(19) United States
(12) Patent Application Publication
(10) Pub. No.: US 2025/0100087 A1
(43) Pub. Date: Mar. 27, 2025

(54) SILVER BRAZE ALLOYS FOR POLY-CRYSTALLINE DIAMOND CUTTERS

(71) Applicant: OERLIKON METCO (US) INC., Westbury, NY (US)

(72) Inventors: James Nathaniel VECCHIO, San Diego, CA (US); Zhe ZHANG, Houston, TX (US); Dongmyoung LEE, Novi, MI (US)

(73) Assignee: OERLIKON METCO (US) INC., Westbury, NY (US)

(21) Appl. No.: 18/729,756

(22) PCT Filed: Feb. 10, 2023
(86) PCT No.: PCT/US2023/012816

§ 371 Date: Jul. 17, 2024

Related U.S. Application Data
(60) Provisional application No. 63/309,065, filed on Feb. 11, 2022.

(51) Int. Cl. B23K 35/30; B23K 35/02; C22C 30/02; C22C 30/04; C22C 30/06

(52) U.S. Cl. CPC B23K 35/3006; B23K 35/0222; C22C 30/02; C22C 30/04; C22C 30/06

(57) ABSTRACT

A novel silver braze alloy material is provided which exhibits both a low melting temperature and excellent wettability when brazing components of an article, such as a tools that include a polycrystalline diamond compact. For example, the combination of these properties is beneficial in terms of cost (given the lower silver content) as well as for brazing a cutter to a drill bit body by forming a strong bond (via the high wettability property) and reducing potential damage to the drill bit during the brazing operation (via the low melting temperature property of the alloy).

### CROSS-REFERENCE TO RELATED APPLICATION

This application claims the benefit under 35 U.S.C. § 119 (e) of U.S. Provisional Application No. 63/309,065 filed Feb. 11, 2022, the disclosure of which is expressly incorporated by reference herein in its entirety.

### BACKGROUND OF THE INVENTION

### 1. Field of the Disclosure

The present disclosure relates to brazing alloys/materials and methods for securing bodies to one another, such as securing cutting elements to drill bits.

### 2. Background Information

Earth engaging drill bits are used extensively by industries including the mining, oil and gas industries for exploration and retrieval of minerals and hydrocarbon resources. Examples of earth-engaging drill bits include fixed cutter drill bits.

Cutting elements used in such tools often include polycrystalline diamond compact (often referred to as “PDC”) cutting elements, which are cutting elements that include cutting faces of a polycrystalline diamond material. Polycrystalline diamond material is material that includes inter-bonded grains or crystals of diamond material.

Cutting elements may be secured to a body, such as to fixed-cutter earth-boring rotary drill bits (also referred to as “drag bits”). Such fixed-cutter bits typically include a plurality of cutting elements fixedly attached to a bit body of the drill bit, conventionally in pockets formed in blades and other exterior portions of the bit body. Other earth boring tools may include rolling-cone earth-boring drill bits, which include a plurality of roller cones attached to bearing pins on legs depending from a bit body. The roller cones may include cutting elements (sometimes called “inserts”) attached to the roller cones, conventionally in pockets formed in the roller cones.

Brazing is widely used to join cutting elements to such earth-boring tools and components thereof by a braze material (e.g., a filler material) that melts upon heating. The braze material coats the surfaces of materials being joined, cooling and solidifying to form a bond. Braze materials typically wet surfaces of the materials being joined and allow the materials to be joined without changing the physical properties of the materials. Braze materials are conventionally selected to melt at a lower temperature than a melting temperature or temperatures of the materials being joined. During a brazing process, heating and cooling of the materials may take place in the open atmosphere, in a controlled atmosphere furnace, or in a vacuum furnace. Braze materials are often alloys based on metals such as Ag, Al, Au, Cu, Ni, Ti, Fe, and alloys thereof. Brazing can be used effectively to join similar or dissimilar materials (e.g., metals to metals, ceramics to ceramics, and metals to ceramics).

Stainless steel and hard metals, such as cemented carbides, are difficult to braze materials. A brazed alloy is required to have an excellent wetting property with the base material to provide a high bonding strength. A high braze temperature results in a high residual stress inside the joint and base material, which results in cracking. To decrease the residual stress, a low melting temperature is required for the brazing material.

Typically, in a brazing process, a filler metal or alloy is heated to a high braze temperature and distributed between two or more close-fitting parts by direct placement of the filler material between the parts. The filler metal or alloy may be drawn into an interface between the parts by capillary action. At the melting temperature of a braze material, molten braze material interacts with the surfaces of the parts, cooling to form a strong, sealed joint (thus, brazed that have an excellent wetting property with the base material to provide a high bonding strength are very desirable).

However, high braze temperatures often result in a high residual stress inside the joint and base material, which results in cracking. To decrease the residual stress, a low melting temperature is required for the brazing material. Typical low melting temperature braze materials include silver brazing alloys, such as BAg 7, BAg 22, and BAg 24. While BAg 7 has a low melting temperature, this brazing alloy has a poor wetting property to tungsten carbide, which is the material that composes the drill bit and cutter body. While BAg 22 and BAg 24 have an improved wetting property to tungsten carbide, these brazing alloys have a 40-50° C. higher melting temperature of 660-705° C. and 680-705° C., respectively, which results in damage to the cutter during drilling operation.

Additionally, the driving cost of silver brazing alloys is silver. Thus, it would be desirable to have a material which performs equivalent to materials, such as BAg 7, BAg 22, and BAg 24, used to braze tungsten inserts, but with lower Ag content.

Accordingly, there exists a need for a brazing material that is low cost, and has a low melting temperature and an excellent tungsten carbide wetting property to prevent damage to a PDC cutter during attachment to a drill bit.

### SUMMARY

The aim of the present disclosure is to obtain a low cost braze material having a low melting temperature and a high tungsten carbide wetting property for brazing a PDC cutter to a drill bit.

In some embodiments, the brazing material includes: 15.2-33.6 wt. % of Cu; 18.4-33.6 wt. % of Zn; 1.6-6 wt. % of Sn; 3.2-4.8 wt. % of Mn; 1.6-4.8 wt. % of Co; and a balance of Ag. In such embodiments, the weight percent of the Cu may preferably be in the range of from 17.1-30.8 wt. %, more preferably the weight percent of the Cu is in the range of from 18-29.4 wt. %. In such embodiments, the weight percent of the Zn may be preferably in the range of from 20.7-30.8 wt. %, more preferably the weight percent of the Zn is in the range of from 21.8-29.4 wt. %. In such embodiments, the weight percent of the Sn may be preferably in the range of from 1.8-5.5 wt. %, more preferably the weight percent of the Sn may is in the range of from 1.9-5.25 wt. %. In such embodiments, the weight percent of the Mn may be preferably in the range of from 3.6-4.4 wt. %, more preferably the weight percent of the Mn is in the range of from 3.8-4.2 wt. %. In such embodiments, the weight percent of the Co may be preferably in the range of from 1.8-4.4 wt. %, more preferably the weight percent of the Co is in the range of from 1.9-4.2 wt. %.

In other embodiments, the brazing material may consist of: 22.4-33.6 wt. % of Cu, 18.4-27.6 wt. % of Zn, 1.6-2.4 wt. % of Sn, 3.2-4.8 wt. % of Mn; and 1.6-2.4 wt. % of Co; where the balance is Ag, except for impurities ordinarily associated therewith.

In other embodiments, the brazing material may consist of: about 41 wt. % of Ag; about 28 wt. % of Cu; about 23 wt. % of Zn; about 2 wt. % of Sn; about 4 wt. % of Mn; and about 2 wt. % of Co, except for impurities ordinarily associated therewith.

In other embodiments, the brazing material may consist of: about 40 wt. % of Ag; about 19 wt. % of Cu; about 28 wt. % of Zn; about 5 wt. % of Sn; about 4 wt. % of Mn; and about 4 wt. % of Co, except for impurities ordinarily associated therewith.

In some embodiments, the brazing material of any of the aforementioned embodiments may be in the form of a powder, atomized powder, paste, tape, wire, sheet or preform.

In aspects of the invention of the present disclosure, the brazing material of any of the aforementioned embodiments may be formulated such that the microstructure of the brazing material (e.g., when observed at standard temperature and pressure (IUPAC)) consists essentially of a eutectic structure.

### BRIEF DESCRIPTION OF THE DRAWINGS

The present disclosure is further described in the detailed description which follows, in reference to the noted plurality of drawings, by way of non-limiting examples of preferred embodiments of the present disclosure.

FIG. 1 is a simplified illustration of the experimental setup that was used to assess the wettability/spreading property of brazing materials.

FIGS. 2A and 2B are SEM images of a brazing material of the present disclosure (Example 1).

FIGS. 3A and 3B are SEM images of a brazing material of the present disclosure (Example 2).

FIGS. 4A and 4B are SEM images of a comparative brazing material (Comparative Example 1).

FIGS. 5A and 5B illustrate a side-by-side comparison of a brazing material of the present disclosure (Example 1; FIG. 5A) and a comparative brazing material (Comparative Example 1; FIG. 5B).

FIGS. 6A and 6B illustrate a side-by-side comparison of a brazing material of the present disclosure (Example 3; FIG. 6B) and a comparative brazing material (Comparative Example 2; FIG. 6A).

FIG. 7 illustrates the measurement technique for determining the phase width in the microstructure of a brazing alloy (Comparative Example 1).

### DETAILED DESCRIPTION

When introducing elements of various embodiments described herein, the articles “a,” “an,” “the,” and “said” are intended to mean that there are one or more of the elements, unless otherwise indicated. The terms “comprising,” “including,” and “having” are intended to be inclusive, and mean that there may be additional elements other than the listed elements. As used herein, the term “and/or” includes any and all combinations of one or more of the associated listed items.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value. In some instances (such as, for example, when used in connection with a weight percentage (wt. %), size/thickness, temperature, etc.), the term “about” means a range of ±5.0% of the number shown. For example, a silver (Ag) weight percentage of “about 40 wt. %” ranges from 42.0 wt. % to 38 wt. %.

In the present disclosure, unless otherwise noted, all weight percentages pertaining to an element of a silver braze alloy are based on the total weight of the silver braze alloy including any unavoidable impurities that may be present.

As used herein, the term “liquidus temperature” generally refers to a temperature at which an alloy is transformed from a solid into a molten or viscous state. The liquidus temperature specifies the maximum temperature at which crystals can co-exist with the melt in thermodynamic equilibrium. Above the liquidus temperature, the alloy is homogeneous, and below the liquidus temperature, more and more crystals begin to form in the melt with time, depending on the alloy. Generally, an alloy, at its liquidus temperature, melts and forms a seal between two components to be joined.

The liquidus temperature can be contrasted with a “solidus temperature”. The solidus temperature quantifies the point at which a material completely solidifies (crystallizes). The liquidus and solidus temperatures do not necessarily align or overlap. If a gap exists between the liquidus and solidus temperatures, then within that gap, the material consists of solid and liquid phases simultaneously (like a “slurry”).

Typically, “brazing” uses a braze material (usually an alloy) having a lower liquidus temperature than the melting points of the components (i.e., their materials) to be joined. The braze material is brought slightly above its melting (or liquidus) temperature while protected by a suitable atmosphere. The braze material then flows over the components (known as wetting), and is then cooled to join the components together. As used herein, “braze material”, “braze alloy composition”, “braze alloy” or “brazing alloy” refers to a composition that has the ability to wet the components to be joined, and to seal them. The composition (which has the ability to wet the components to be joined, and to seal them) may be in any suitable form known to those skilled in the art, such as, for example, in the form of a powder, atomized powder, paste, tape, wire, sheet or preform. A braze material, for a particular application, should withstand the service conditions required, and melts at a lower temperature than the base materials; or melts at a very specific temperature.

As used herein, the term “sealing” refers to a function performed by a structure (e.g., a structure formed by a braze alloy) that joins or bonds other structures together. The seal structure may also be referred to as a “seal”. In embodiments, the seal structure may reduce or prevent leakage through the joint (between the other structures being joined and/or bonded together).

As used herein, the term “brazing temperature” refers to a temperature to which a brazing structure is heated to allow a braze alloy to wet the components to be joined, and to form a braze joint or seal. The brazing temperature is often higher than or equal to the liquidus temperature of the braze alloy. In addition, the brazing temperature should be lower than the temperature at which the components to be joined may not remain chemically, compositionally, and mechanically stable.

As used herein, the term “polycrystalline material” refers to any structure comprising a plurality of grains (i.e., crystals) of material that are bonded directly together by inter granular bonds. The crystal structures of the individual grains of the material may be randomly oriented in space within the polycrystalline material.

As used herein, the term “diamond” means and includes any material composition that contains an allotrope of carbon, wherein the carbon atoms are arranged in a diamond lattice structure, typically characterized by a tetrahedral bond structure. Diamond includes, for example, natural and synthetic diamonds and polycrystalline and monocrystalline diamond.

As used herein, the term “tungsten carbide” means and includes any material composition that contains chemical compounds of tungsten and carbon, such as WC, W₂C, and combinations of WC and W₂C. Tungsten carbide includes, for example, cast tungsten carbide, sintered tungsten carbide, and microcrystalline tungsten carbide.

The present disclosure provides silver braze alloys of the Ag—Cu—Zn—Mn—Sn alloy system/family, which optionally may include cobalt, that have low melting points and can be brazed at low temperatures.

### Formulation 1:

In embodiments, the silver braze alloys of Formulation 1 may have a composition that falls within the following compositional ranges (where each weight percent (wt. %) identified below is based on the total weight of: Silver (Ag), copper (Cu), Zinc (Zn), Tin (Sn), Manganese (Mn), Cobalt (Co) and any unavoidable impurities present in the composition):
(i) Silver (Ag) content: less than 50 wt. % Ag, preferably less than 45 wt. % Ag, more preferably less than 43 wt. % Ag, for example, in some embodiments, the Ag may be present at a weight percent that is in the range of from 42 wt. % to 32 wt. %, more particularly from 42 wt. % to 38 wt. %;
(ii) copper (Cu) content: Cu may be present as a primary alloying element and may be present at a weight percent that is in the range of from 15.2 wt. % to 33.6 wt. %, preferably 17.1 wt. % to 30.8 wt. %, more preferably 18 wt. % to 29.4 wt. %;
(iii) Zinc (Zn) content: Zn may be present as a primary alloying element and may be present at a weight percent that is in the range of from 18.4 wt. % to 33.6 wt. %, preferably 20.7 wt. % to 30.8 wt. %, more preferably 21.8-29.4 wt. %;
(iv) Tin (Sn) content: Zn may be present as a minor alloying element and may be present at a weight percent that is in the range of from 1.6 wt. % to 6.0 wt. %, preferably 1.8 wt. % to 5.5 wt. %, more preferably 1.9 wt. % to 5.25 wt. %;
(v) Manganese (Mn) content: Mn may be present as a minor alloying element and may be present at a weight percent that is in the range of from 3.2 wt. % to 4.8 wt. %, preferably 3.6 wt. % to 4.4 wt. %, more preferably 3.8 wt. % to 4.2 wt. %; and
(vi) Cobalt (Co) content: Co may be present as a minor alloying element and may be present at a weight percent that is in the range of from 1.6 wt. % to 4.8 wt. %, preferably 1.8 wt. % to 4.4 wt. %, more preferably 1.9 wt. % to 4.2 wt. %.

In particular embodiments, the silver braze alloys of Formulation 1 may have a composition that falls within the following compositional ranges: 22.4 wt. % to 33.6 wt. % Cu, 18.4 wt. % to 27.6 wt. % Zn, 1.6 wt. % to 2.4 wt. % Sn, 3.2 wt. % to 4.8 wt. % Mn, and 1.6 wt. % to 2.4 Co, where the balance is Ag.

In specific embodiments, the silver braze alloys of Formulation 1 may have a composition in which the weight percent of Ag is about 41 wt. %, the weight percent of Cu is about 28 wt. %, the weight percent of Zn is about 23 wt. %, the weight percent of Sn is about 2 wt. %, the weight percent of Mn is about 4 wt. %, and the weight percent of Co is about 2 wt. %.; or, more particularly, a composition in which the weight percent of Ag is 41 wt. %, the weight percent of Cu is 28 wt. %, the weight percent of Zn is 23 wt. %, the weight percent of Sn is 2 wt. %, the weight percent of Mn is 4 wt. %, and the weight percent of Co is 2 wt. %.

In other specific embodiments, the silver braze alloys of Formulation 1 may have a composition in which the weight percent of Ag is about 40 wt. %, the weight percent of Cu is about 19 wt. %, the weight percent of Zn is about 28 wt. %, the weight percent of Sn is about 5 wt. %, the weight percent of Mn is about 4 wt. %, and the weight percent of Co is about 4 wt. %; or, more particularly, a composition in which the weight percent of Ag is 40 wt. %, the weight percent of Cu is 19 wt. %, the weight percent of Zn is 28 wt. %, the weight percent of Sn is 5 wt. %, the weight percent of Mn is 4 wt. %, and the weight percent of Co is 4 wt. %.

In embodiments, the silver braze alloys of Formulation 1 may exhibit a melting temperature (a solidus, or temperature above which the composition begins to melt) in a range of from 590° C. to 721° C., preferably in a range of from 623° C. to 688° C., more preferably in a range of from 636° C. to 675° C.

In some embodiments, the silver braze alloys of Formulation 1 may exhibit narrow melting temperature ranges of less than 61° C., preferably less than or equal to 45° C., more preferably less than or equal to 43° C., and/or low solidus temperatures of less than or equal to 721° C., preferably than or equal to 688° C., more preferably less than or equal to 675° C., and/or low liquidus temperatures of less than or equal to 725° C., preferably than or equal to 710° C., more preferably less than or equal to 700° C., as determined by Differential Scanning calorimetry (DSC).

In embodiments, the silver braze alloys of Formulation 1 may exhibit a melting temperature (a solidus, or temperature above which the composition begins to melt) in a range of from 609° C. to 499° C., preferably in a range of from 582° C. to 526° C., more preferably in a range of from 571° C. to 537° C.

In some embodiments, the silver braze alloys of Formulation 1 may exhibit narrow melting temperature ranges of less than 99° C., preferably less than or equal 73° C., more preferably less than or equal to 69° C., and/or low solidus temperatures of less than or equal to 609° C., preferably than or equal to 582° C., more preferably less than or equal to 571° C., and/or low liquidus temperatures of less than or equal to 650° C., preferably than or equal to 630° C., more preferably less than or equal to 625° C., as determined by Differential Scanning calorimetry (DSC).

In some embodiments, aside from unavoidable impurities, any of the silver braze alloys of Formulation 1 may be a composition that is free from one or more (or all) of the following elements: cadmium (e.g., cadmium is toxic to the environment and human beings), phosphorous, nickel (e.g., nickel is a known to create toxic fumes when vaporized), indium, silicon, antimony, palladium, gold, iridium, rhodium, ruthenium, osmium, platinum, titanium, lithium, germanium, molybdenum and/or iron.

### Formulation 2:

In embodiments, the silver braze alloys of Formulation 2 may have a composition that falls within the following compositional ranges: less than 50 wt. % Ag, 20.8 wt. % to 32.9 wt. % Cu, 18.2 wt. % to 33.1 wt. % Zn, 0.7 wt. % to 2.3 wt. % Sn, 3.3 wt. % to 5.6 wt. % Mn, and 3.4 wt. % to 5.0 wt. % Co; preferably a composition falling within the following compositional ranges: less than 50 wt. % Ag, 20.8 wt. % to 31.2 wt. % Cu, 18.2 wt. % to 27.2 wt. % Zn, 1.5 wt. % to 2.3 wt. % Sn, 3.8 wt. % to 5.6 wt. % Mn and 3.4 wt. % to 5.0 wt. % Co; more preferably a composition falling within the following compositional ranges: less than 45 wt. % Ag, 21.9 wt. % to 32.9 wt. % Cu, 22.1 wt. % to 33.1 wt. % Zn, 0.7 wt. % to 1.1 wt. % Sn, 3.3 wt. % to 4.9 wt. % Mn and 3.4 wt. % to 5.0 wt. % Co.

In embodiments, the silver braze alloys of Formulation 2 may exhibit a melting temperature (a solidus, or temperature above which the composition begins to melt) in a range of from 593° C. to 725° C., preferably in a range of from 626° C. to 692° C., more preferably in a range of from 639° C. to ° C.

In some embodiments, the silver braze alloys of Formulation 2 may exhibit narrow melting temperature ranges of less than 102° C., preferably less than or equal to 75° C., more preferably less than or equal to 71° C., and/or low solidus temperatures of less than or equal to 725° C., preferably than or equal to 692° C., more preferably less than or equal to 679° C., and/or low liquidus temperatures of less than or equal to 775° C., preferably than or equal to 750° C., more preferably less than or equal to 730° C., as determined by Differential Scanning calorimetry (DSC).

In some embodiments, aside from unavoidable impurities, any of the silver braze alloys of Formulation 2 may be a composition that is free from one or more (or all) of the following elements: cadmium (e.g., cadmium is toxic to the environment and human beings), phosphorous, nickel (e.g., nickel is a known to create toxic fumes when vaporized), indium, silicon, antimony, palladium, gold, iridium, rhodium, ruthenium, osmium, platinum, titanium, lithium, germanium, molybdenum and/or iron.

### Formulation 3:

In embodiments, the silver braze alloys of Formulation 3 may have a composition that falls within the following compositional ranges: 0 wt. % to 15 wt. % Cu, 12 wt. % to 35 wt. % of Zn, 9 wt. % to 15 wt. % of Sn, 2 wt. % to 16 wt. % of Mn, and a balance of Ag; particularly a composition falling within the following compositional ranges 0.7 wt. % to 1 wt. % Cu, 13 wt. % to 20 wt. % Zn, 10 wt. % to 15 wt. % Sn, 11 wt. % to 16 wt. % Mn, and the balance being Ag. In an embodiment, the silver braze alloys of Formulation 3 may have a content of Cu that is greater than 0 wt. % but less than 5% wt. % of Cu, preferably a content of Cu that is greater than 0 wt. % but less than 2% wt. % of Cu.

In some embodiments, aside from unavoidable impurities, any of the silver braze alloys of Formulation 3 may be a composition that is free from one or more (or all) of the following elements: cadmium (e.g., cadmium is toxic to the environment and human beings), phosphorous, nickel (e.g., nickel is a known to create toxic fumes when vaporized), indium, silicon, antimony, palladium, gold, iridium, rhodium, ruthenium, osmium, platinum, titanium, lithium, germanium, molybdenum and/or iron.

### Formulation 4:

In embodiments, the silver braze alloys of Formulation 4 may have a composition that falls within the following compositional ranges: 0 wt. % to 1.2 wt. % of Cu, 28 wt. % to 42 wt. % of Zn, 8 wt. % to 12 wt. % of Sn, 11 wt. % to 17 wt. % of Mn, and a balance of Ag.

In embodiments, the silver braze alloys of Formulation 4 may exhibit a melting temperature (a solidus, or temperature above which the composition begins to melt) in a range of from 483° C. to 591° C., preferably in a range of from 510° C. to 564° C., more preferably in a range of from 521° C. to 553° C.

In some embodiments, the silver braze alloys of Formulation 4 may exhibit narrow melting temperature ranges of less than 186° C., preferably less than or equal to 136° C., more preferably less than or equal to 130° C., and/or low solidus temperatures of less than or equal to 591° C., preferably than or equal to 564° C., more preferably less than or equal to 553° C., and/or low liquidus temperatures of less than or equal to 186° C., preferably than or equal to 136° C., more preferably less than or equal to 130° C., as determined by Differential Scanning calorimetry (DSC).

In some embodiments, aside from unavoidable impurities, any of the silver braze alloys of Formulation 4 may be a composition that is free from one or more (or all) of the following elements: cadmium (e.g., cadmium is toxic to the environment and human beings), phosphorous, nickel (e.g., nickel is a known to create toxic fumes when vaporized), indium, silicon, antimony, palladium, gold, iridium, rhodium, ruthenium, osmium, platinum, titanium, lithium, germanium, molybdenum and/or iron.

### Formulation 5:

In some embodiments, it may be desirable to reduce the Sn content while maintaining a low liquidus temperature and a high Mn content for the purpose of increasing the silver braze alloy toughness. Such embodiments may be formulated to have a composition falling within the following compositional ranges (Formulation 5): up to 2 wt. % Cu, 13 wt. % to 20 wt. % Zn, 11 wt. % to 16% Mn, 1 wt. % to 10% wt. % to Sn, and a balance of Ag.

In some embodiments, aside from unavoidable impurities, any of the silver braze alloys of Formulation 5 may be a composition that is free from one or more (or all) of the following elements: cadmium (e.g., cadmium is toxic to the environment and human beings), phosphorous, nickel (e.g., nickel is a known to create toxic fumes when vaporized), indium, silicon, antimony, palladium, gold, iridium, rhodium, ruthenium, osmium, platinum, titanium, lithium, germanium, molybdenum and/or iron.

In embodiments, the silver braze alloys of Formulations 1-5 may be manufactured in the form of a powder, an amorphous foil, an atomized powder, paste (such as a paste based on the powder), a tape (such as a tape based on the powder), wire, sheet, preform (such as sintered preforms), a powder spray coating with a binder, or a screen printing paste. The silver braze alloys of Formulations 1-5 may be applied by spraying, or by screen printing.

The silver braze alloys of Formulations 1-5 may be made using conventional methods for producing braze alloys. For example, as conventional in the art, all of the elements or metals in the desired proportions may be mixed together and melted to form a chemically homogenous alloy (which may, for example, be atomized into a chemically homogeneous alloy powder).

In some embodiments, the chemically homogeneous alloy may have a microstructure that is mainly (e.g., more that 50% of the total area, preferably more than 75% of the total area, more preferably more than 90% of the total area) a eutectic structure. In some embodiments, the composition of the present disclosure may be selected such that it has microstructure that consists essentially of a eutectic structure. As used in this context, the term “consists essentially of” means that the structure does not contain any microstructure and/or phase other than the eutectic structure that significantly changes (e.g., more than about 0.5%, 1%, or 5%) a behavior and/or function of interest (such as, for example, the solidus temperature, liquidus temperature, etc.) of the silver braze alloy.

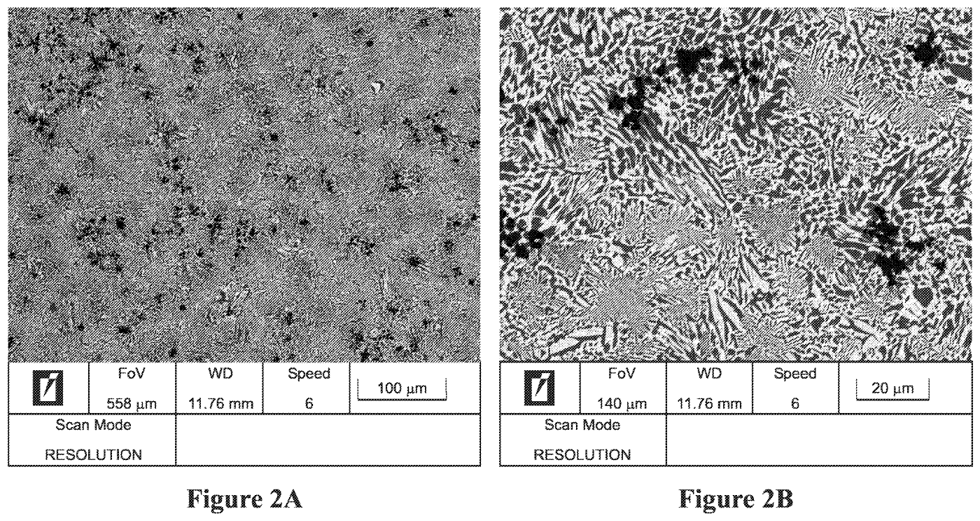

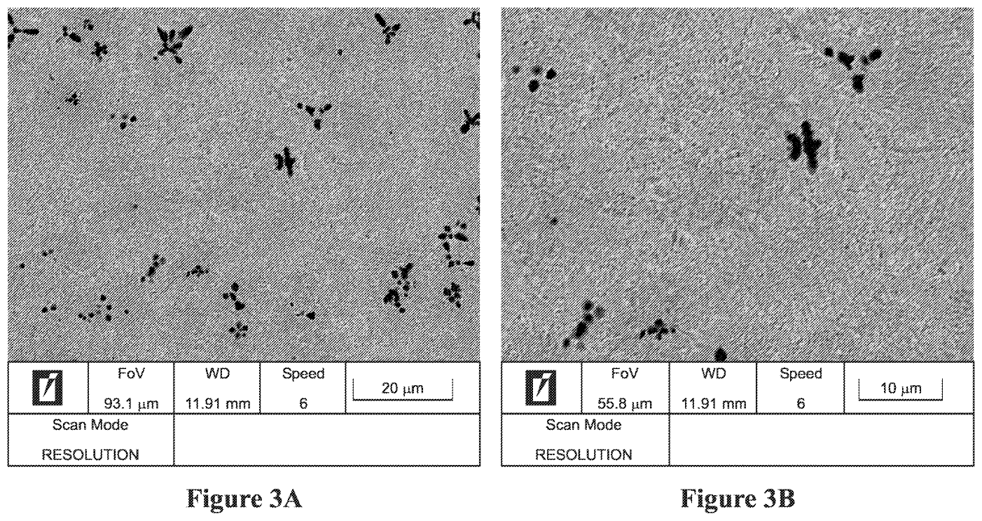

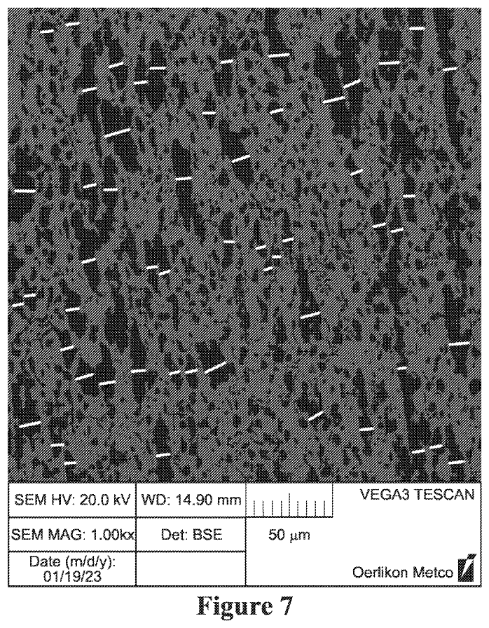

In some embodiments, the chemically homogeneous alloy may have a microstructure that is mainly (e.g., more that 50% of the total area, preferably more than 90% of the total area, more preferably more than 95% of the total area, still more preferably more than 99% of the total area) a eutectic structure. In some embodiments, the eutectic structure may include fine dark grey (black) and “white” phases next each other (for example, as illustrated in FIGS. 2A, 2B, 3A and 3B). Preferably, the fine dark grey (black) phase/dark precipitates may have a mean width of 5 μm or smaller. More preferably, the eutectic structure contains phases (e.g., of dark precipitates or fine dark grey (black) precipitates) with a mean width of 3 μm or smaller. In still more preferred embodiments, the eutectic structure contains phases (e.g., of dark precipitates or fine dark grey (black) precipitates) with a mean width of 1 μm or smaller. In some embodiments, the chemically homogeneous alloy may have a microstructure that is mainly (e.g., more that 50% of the total area, preferably more than 90% of the total area, more preferably more than 95% of the total area, still more preferably more than 99% of the total area) a eutectic structure that only contains fine dark phases (e.g., of fine dark precipitates or fine dark grey (black) precipitates). Preferably, the fine dark phases (dark grey (black) precipitates) that are present in such embodiments will have a maximum width of 5.0 μm or smaller, more preferably the eutectic structure will only contain fine dark phases (e.g., of fine dark precipitates or fine dark grey (black) precipitates) with a maximum width of 3.1 μm or smaller, still more preferably the eutectic structure will only contain fine dark phases (e.g., of fine dark precipitates or fine dark grey (black) precipitates) with a maximum width of 1.0 μm or smaller. Such characteristics of a phase (such as the width/maximum width of a dark (black) phase) may be as assessed by the methodology that is illustrated in FIG. 7 (which shows a microstructure of Comparative Example 1 with coarse primary dark (black) and “white” phases) in which the various straight lines drawn across the “small axis” of the dark (black) precipitates represent the measurements of phase width (i.e., for the Comparative Example 1 (BAg 24) braze microstructure). In the case of Comparative Example 1 (BAg 24), the phase width (of the dark phases) was measured to have an 8 μm mean, minimum of 3.7 μm and maximum of 14.23 μm. In contrast, the phase width of the fine dark phases of Example 1 was measured have an a 1.46 μm mean, minimum of 0.76 μm and maximum of 3.1 μm; and the maximum phase width of the fine dark phases of Example 2 was measured to be less than 1 μm.

In embodiments, the compositions of the present disclosure are selected to be at or very close to the true eutectic point of the primary elements of this system of the present disclosure, which is the temperature at which the melting and solidification occur at a single temperature for a pure element or compound, rather than over a range. Reducing the solidus temperature and the liquidus temperature to narrow the melting range of the silver braze alloy provides alloys which behave more like a eutectic composition (i.e., where there is no difference between the solidus and the liquidus temperatures). The narrowed down melting range (particularly, for example, with respect to Formulations 1 and 2) provides alloys with brazing temperatures of less than 800° C., preferably less than 775° C., or less than 750° C., with good wetting and spreading capabilities.

Embodiments described herein also relate to methodology for bonding bodies, such methodology including disposing a braze material including one or more silver braze alloys of Formulations 1-5 between a first body and a second body, heating the braze material to a brazing temperature, optionally maintaining the brazing temperature of the braze material for a period of time, and then solidifying the braze material to form a bond between the first body and the second body.

The first body may be, for example, a bit body, a reamer, a roller cone, a substrate of a cutting element, or the like. The first body may include tungsten carbide, one or more metals, such as iron-based steel, another alloy, a metal-matrix composite, or the like. The second body may include a polycrystalline material, such as diamond, cubic boron nitride, tungsten carbide, one or more metals, such as iron-based steel, another alloy, a metal-matrix composite, or the like. For example, the second body may be a cutting element that includes a polycrystalline material over (e.g., bonded to) a supporting substrate. In some embodiments, the second body may be a cutting element including a polycrystalline diamond table bonded to a cemented tungsten carbide substrate.

In some embodiments, the silver braze alloy(s) of Formulations 1-5 that is selected for the braze material may be applied to a volume between the first body and the second body in any desired manner. For example, the braze material may initially be a mixture of particles of the composition disposed between the first body and the second body. In such embodiments, the silver braze alloy(s) of Formulations 1-5 that is selected for the braze material may have an average particle size in the range of from about 1 nm (nanometer) to about 100 μm, from about 30 nm to about 1 μm, from about 100 nm to about 500 nm, from about 1 μm to about 50 μm, or from about 5 μm to about 30 μm.

In some embodiments, if the composition is initially applied between the first body and the second body in the form of one or more layers, the one or more layers may have a thickness that is suitable for the intended application. In some embodiments, the thickness, for example, may be in a range of from about 5 μm to about 2 mm, from about 100 μm to about 1 mm, or from about 200 μm to about 500 μm.

In some embodiments, the composition of the present disclosure that is selected for the braze material may constitute about 95 wt. % of the braze material, preferably about 99 wt. % of the braze material, or 99.9 wt. % of the braze material, or 100 wt. % of the braze material that ultimately forms the bond between the first body and the second body.

In some embodiments, the first body, braze material, and second body may be heated to a temperature above a melting point of the composition of the present disclosure that is selected for the braze material. For example, the braze material may be heated to a temperature from about 700° C. to about 800° C., preferably from about 725° C. to about 775° C., more preferably from about 740° C. to about 760° C.

The braze material may be heated in controlled steps known to those skilled in the art, such as in an inert atmosphere. In embodiments, the braze may be conducted in open air using a commercially available flux, such as, for example, TENACITY™ No. 6 flux paste (FB3C) (which contains 15-25% water, 50-75% potassium borates, 1-3% boric acid, 10-20% potassium fluorides, and 1-3% boron), or the like. Alternatively, the braze material may be heated in a vacuum or in an environment pressurized with an inert gas (e.g., argon, nitrogen, helium, etc.). Pressure of up to about 1 MPa, up to about 5 MPa, up to about 10 MPa, or even up to about 30 MPa may be maintained throughout the heating process.

In some embodiments, the braze/bond that is ultimately formed between the first body and the second body may be a homogeneous or substantially homogeneous material. In other embodiments, the braze may have a composition gradient (e.g., a volume of relatively higher concentration of a certain species and another volume of relatively lower concentration of another species).

The present invention is further illustrated by the following non-limiting examples where all parts, percentages, proportions, and ratios are by weight, all temperatures are in ° C., and all pressures are atmospheric unless otherwise indicated:

### Examples

In the present disclosure and Examples below, the solidus temperature, liquidus temperature, and melting range of the materials/compositions/alloys are determined herein by Differential Scanning calorimetry (DSC) in accordance with the NIST practice guide, Boettinger, W. J. et al, “DTA and Heat-flux DSC Measurements of Alloy Melting and Freezing” National Institute of Standards and Technology, special Publication 960-15, November 2006, the disclosure of which is herein incorporated by reference in its entirety. In making the determinations the individual metallic powders are mixed and melted to form an alloy, the resulting alloy is solidified, the solidified alloy is ground to form a powdered alloy, and then the powdered alloy is subjected to the DSC analysis. The liquidus and solidus temperatures are determined by the profiles of the second heatings, which provides for better conformity of the alloy to the shape of the crucible, and more accurate determinations as indicated, for example, at page 12 of the NIST practice guide. The DSC analysis is performed using a STA-449 DSC of Netzsch (Proteus Software) with a 25° C./min heating rate from 30° C. to 740° C., or to a higher temperature as needed to exceed the liquidus temperature. The cooling rate employed for the DSC analysis from above the liquidus temperature back down to room temperature is also at 25° C./min, but other cooling rates may be used.

The wetting/spreading behavior of the alloys of the present disclosure was assessed as follows.

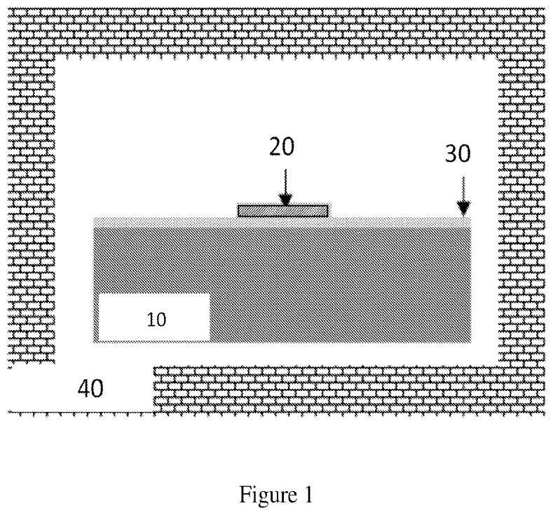

FIG. 1 is a simplified illustration of the experimental set-up to test the wetting/spreading behavior. The substrate 10 is a 1″×1″×0.25″ substrate made of WC-10Co (acquired from GRAINGER®; grade of C2, submicron grain, with a 10% cobalt content). Before conducting the tests, the substrate (which, as-received/purchased from the vendor, has a surface layer of a substance with gray color) was polished with an 80 grade diamond pad until the gray layer was fully removed and a fresh surface material was fully exposed. After polishing, the substrate was ultrasonically cleaned with alcohol. Prior to testing, a 0.05 gram sample of the alloy to be tested was ultrasonically cleaned with alcohol. The cleaned 0.05 gram sample 20 was placed onto the substrate 10 and covered with FB3C flux paste 30. Then, the assembled substrate and sample were inserted into a furnace 40 at 750° C. for 5 minutes under an air atmosphere. After removing the substrate and tested sample from the furnace, the sample was cooled to ambient temperature via exposure to room atmosphere. Then, the extra flux on the surface of the substrate was cleaned. The spreading area was measured by taking an image of the sample (the image being a top view image that was taken via a light microscope). Once the image was acquired, the spread area of the braze alloy on the substrate was measured through via a commercially available image processing software suitable for calculating the area of an irregular object.

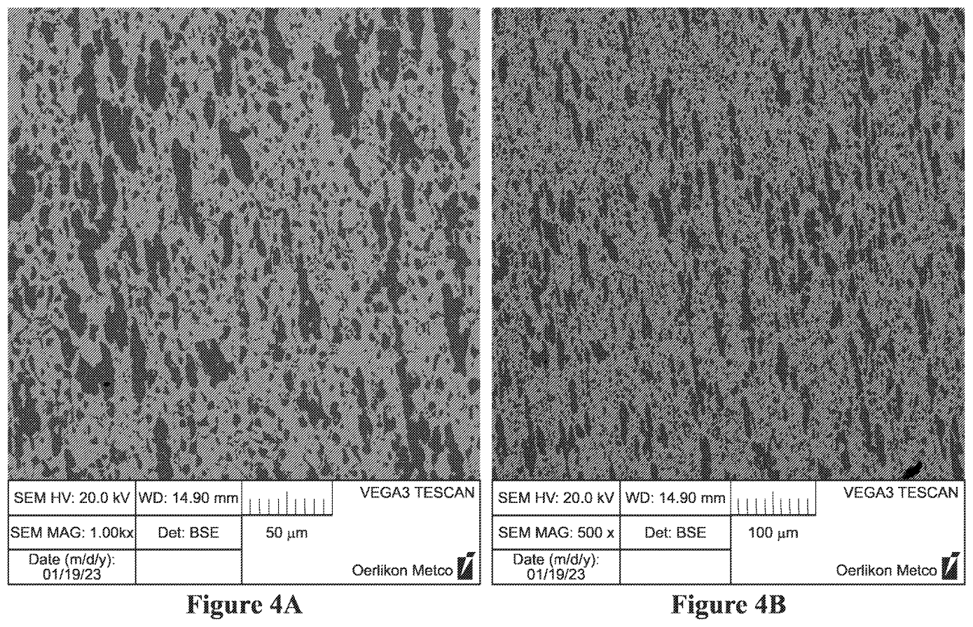

The compositions of Examples 1-3 and the comparative alloys (Comparative Examples 1 and 2) are set forth in Table 1 (below). As seen in Table 1, Example 1 is a silver braze alloy of the present disclosure. FIGS. 2A and 2B show SEM images of the microstructure of Example 1 (as seen in FIGS. 2A and 2B, the microstructure of Example 1 consists essentially of a eutectic structure). Example 2 is also silver braze alloy of the present disclosure. FIGS. 3A and 3B show SEM images of the microstructure of Example 2 (as seen in FIGS. 3A and 3B, the microstructure of Example 2 consists essentially of a eutectic structure). Example 3 relates to a third silver braze alloy of the present disclosure, in which cobalt is absent. Comparative Example 1 is BAg 24, a commercially available silver-based brazing alloy. FIGS. 4A and 4B show SEM images of the microstructure of Comparative Example 1 (as seen in FIGS. 4A and 4B, the microstructure of Comparative Example 1 is mainly a primary Cu rich phase (dark color) and primary Ag rich phase (white color)). Comparative Example 2 is BAg 7, a commercially silver-based brazing alloy used for ferrous and non-ferrous alloys in joints. The compositions of the present disclosure (Examples 1-3) and the comparative alloys (Comparative Examples 1 and 2) with their solidus temperature, liquidus temperature and melting range, all determined by DSC (using the STA 449 (DSC) of Netzsch, using a heating rate and a cooling rate of 10° C./min) are shown in Table 1:

TABLE 1
Melting temperature of data

| | | | | | | | | | | Melting |
|---|---|---|---|---|---|---|---|---|---|---|
| | Composition (wt %) | | | | | | | M.P.(° C.) | | Range |
| Example No. | Ag | Cu | Zn | Sn | Mn | Co | Ni | Solidus | Liquidus | (° C.) |
| Example 1 | 41 | 28 | 23 | 2 | 4 | 2 | — | 655 | 696 | 41 |
| Example 2 | 40 | 19 | 28 | 5 | 4 | 4 | — | 619 | 653 | 35 |
| Example 3 | 40 | 1 | 35 | 10 | 14 | — | — | 537 | 661 | 124 |
| Comparative 1 | 50 | 20 | 28 | 5.0 | — | — | 2 | 672 | 703 | 31 |
| (BAg 24) | | | | | | | | | | |
| Comparative 2 | 56 | 22 | 17 | 5 | — | — | — | 618 | 651 | 33 |
| (BAg 7) | | | | | | | | | | |

The data listed in Table 1 show that the Example 1 showed a liquidus temperature of 696° C. and a solidus temperate of 655° C. Thus, Example 1 has a similar or lower liquidus temperature than Comparative Example 1 while having the additional benefit of lower Ag content.

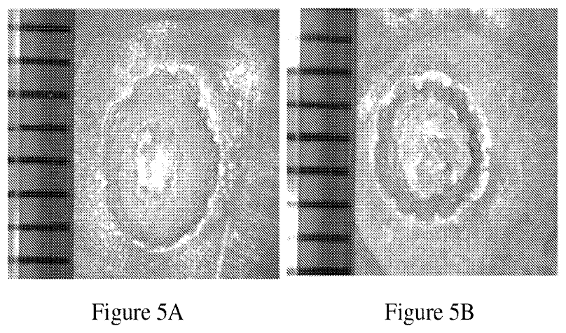

FIGS. 5A and 5B show the results of the wetting/spreading test for Example 1 (FIG. 5A) and Comparative Example 1 (FIG. 5B). The spreading area for Example 1 was determined to be 19.0 mm², whereas the spreading area for Comparative Example 1 was determined to be 14.6 mm². Regarding this test, a larger area represents better wetting behavior with the substrate material. Thus, Example 1 showed improved wettability/spreading (i.e., by a factor of 1.3) in comparison to Comparative Example 1.

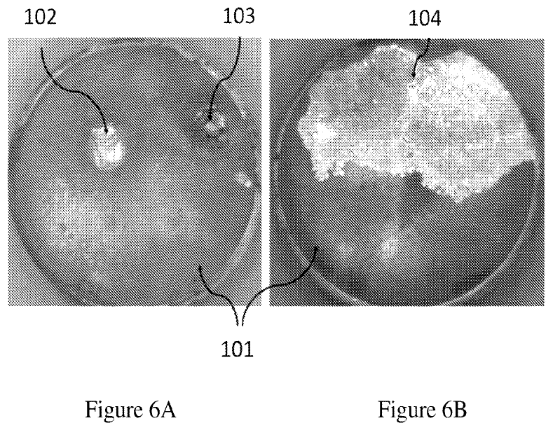

FIGS. 6A and 6B show the wettability/spreading results of a side-by-side comparison of Example 3 (the test sample associated with reference numeral 104 in FIG. 6B) and Comparative Example 2 (the test samples associated with reference numerals 102 and 103 in FIG. 6A). The wettability/spreading test was lightly different from the wetting/spreading test for Example 1 (201) and Comparative Example 1 (202) in that for the test samples 102 and 103, the Comparative Example 2 alloy was cut into small pieces, each with an estimated weight of 0.03-0.04 g. In addition, in this test, the backside of a PDC cutter (reference numeral 101 in FIGS. 6A and 6B) was polished by the steel pad and 3 μm diamond liquid. The Comparative Example 2 alloy and the PDC cutter 101 were ultrasonic cleaned with acetone. To avoid oxidation, the Comparative Example 2 alloy was placed onto the polished PDC cutter 101 and covered with FB3C flux paste. Then, the assembled PDC cutter 101 and Comparative Example 2 alloy were inserted into an open air furnace at 650° C. for 10 min.

The experiment for test sample 104 was conducted the same as that for test samples 102 and 103, except the Example 3 alloy was used instead of the Comparative Example 2 alloy.

As shown in FIGS. 6A and 6B, the Comparative Example 2 alloy exhibited poor wettability to the PDC cutter 101. In contrast, Example 3 of the present disclosure exhibited excellent wettability to the PDC cutter 101.

Further, at least because the invention is disclosed herein in a manner that enables one to make and use it, by virtue of the disclosure of particular exemplary embodiments, such as for simplicity or efficiency, for example, the invention can be practiced in the absence of any step, additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A brazing material, comprising:
15.2-33.6 wt. % of Cu;
18.4-33.6 wt. % of Zn;
1.6-6 wt. % of Sn;
3.2-4.8 wt. % of Mn;
1.6-4.8 wt. % of Co; and
a balance of Ag.

2. The brazing material of claim 1, wherein the weight percent of the Cu is in a range of from 17.1-30.8 wt. %.

3. The brazing material of claim 1, wherein the weight percent of the Cu is in a range of from 18-29.4 wt. %.

4. The brazing material of claim 1, wherein the weight percent of the Zn is in a range of from 20.7-30.8 wt. %.

5. The brazing material of claim 1, wherein the weight percent of the Zn is in a range of from 21.8-29.4 wt. %.

6. The brazing material of claim 1, wherein the weight percent of the Sn is in a range of from 1.8-5.5 wt. %.

7. The brazing material of claim 1, wherein the weight percent of the Sn is in a range of from 1.9-5.25 wt. %.

8. The brazing material of claim 1, wherein the weight percent of the Mn is in a range of from 3.6-4.4 wt. %.

9. The brazing material of claim 1, wherein the weight percent of the Mn is in a range of from 3.8-4.2 wt. %.

10. The brazing material of claim 1, wherein the weight percent of the Co is in a range of from 1.8-4.4 wt. %.

11. The brazing material of claim 1, wherein the weight percent of the Co is in a range of from 1.9-4.2 wt. %.

12. The brazing material of claim 1, wherein the brazing material consists of:
22.4-33.6 wt. % of the Cu,
18.4-27.6 wt. % of the Zn,
1.6-2.4 wt. % of the Sn,
3.2-4.8 wt. % of the Mn;
1.6-2.4 wt. % of the Co; and
the balance being the Ag.

13. The brazing material of claim 1, wherein the brazing material consists of:
about 41 wt. % of the Ag;
about 28 wt. % of the Cu;
about 23 wt. % of the Zn;
about 2 wt. % of the Sn;
about 4 wt. % of the Mn; and
about 2 wt. % of the Co.

14. The brazing material of claim 1, wherein the brazing material consists of:
about 40 wt. % of the Ag;
about 19 wt. % of the Cu;
about 28 wt. % of the Zn;
about 5 wt. % of the Sn;
about 4 wt. % of the Mn; and
about 4 wt. % of the Co.

15. The brazing material of claim 1, wherein a microstructure of the brazing material consists essentially of a eutectic structure.

16. The brazing material of claim 1, which is in the form of a powder, atomized powder, paste, tape, wire, sheet or preform.
